(19) United States
(12) Patent Application Publication
(10) Pub. No.: US 2011/0097982 A1
(43) Pub. Date: Apr. 28, 2011

(54) VENTILATING DEVICE FOR A SLEEPING CABIN

(76) Inventors: STUART MCCLEAN, Oakland, MD (US); LINDA MCCLEAN, Oakland, MD (US)

(21) Appl. No.: 12/604,394

(22) Filed: Oct. 23, 2009

(51) Int. Cl. B60H 1/32; F24F 7/007

(52) U.S. Cl. 454/143; 454/338

(57) ABSTRACT

The present invention relates to a ventilating system for use in a sleeping cabin comprising: a backing plate; a plurality of fans mounted on said backing plate; a plurality of fastening devices, where said fastening devices secure the fans onto the backing plate; and a power supply, where said power supply supplies electrical power to the fans. The ventilating system may further include aluminum clips that provide a means to support the mounting of the fans and a fan grill for each fan. The backing plate may be sized to fit a receiving cabin window. The plurality of fastening devices may include a screw, rivet, clip or stud fastener. In one exemplary embodiment, the power supply includes a wire harness with power connections at each end of the wire harness.

### BACKGROUND OF THE INVENTION

1. Field of Invention

The present invention relates to a ventilating device for use in a cab area of a truck that provides a means to ventilate the sleeping cabin.

2. Description of Related Art

Truckers transport goods and services across the country and many times must sleep or rest within the cabin of their truck. Many trucks are equipped with sleeping cabins that provide a sleeping area for the driver. Because drivers must transfer goods across the country, stops are necessary for overnight sleep or temporary rest and involve possible exposure to the weather conditions and temperature of the sleeping cabin. Therefore many times truck drivers leave their trucks running in order to remain cool where they must park and sleep in warm weather. The continuous running or idling of an engine in order to maintain a cool cabin temperature however results in excess fuel consumption and therefore increases the cost of travel.

In addition to running the vehicle in idle, some systems have been developed that provide small, independent air conditioning control systems that provide temperature control for the cabin. These systems still may use fuel or energy from the engine and also may drain batteries in the truck.

Other schemes to cool the sleeping cabin include simply lowering the windows or providing a small ventilating system within the cabin area to allow for an air flow. These structures provide a passive means to cool the cabin area and therefore may not be as effective as a specific cooling system. Further, many of the venting structures rely upon the movement of outside air which is dependent on weather conditions.

It would be advantageous to have a ventilating system that effectively supplies a cooling airflow in the sleeping cabin, eliminates the need to idle the engine and therefore reduces the costs associated with trucking. The use of such a ventilation system may also reduce the wear and tear on the engine by avoiding engine idle and eliminate the unnecessary emissions that are also released during the idling process.

### SUMMARY OF THE INVENTION

The present invention relates to a ventilating system for use in a sleeping cabin comprising: a backing plate; a plurality of fans mounted on said backing plate; a plurality of fastening devices, where said fastening devices secure the fans onto the backing plate; and a power supply, where said power supply supplies electrical power to the fans. The ventilating system may further include aluminum clips that provide a means to support the mounting of the fans and a fan grill for each fan. The backing plate may be sized to fit a receiving cabin window. The plurality of fastening devices may include a screw, rivet, clip or stud fastener. In one exemplary embodiment, the power supply includes a wire harness with power connections at each end of the wire harness.

### BRIEF DESCRIPTION OF DRAWINGS

FIG. 1 depicts a ventilating system and device according to the present invention.

### DETAILED DESCRIPTION

The present invention relates to a ventilating system and device that may be utilized to cool the sleeping cabin of a truck cab. The ventilating system according to the present invention fits into the cabin window of a sleeping cabin and is easily installed and removed as desired by the user. Use of the ventilating system according to the present invention reduces fuel consumption and eliminates unnecessary emissions while the driver may be using the sleeping cabin.

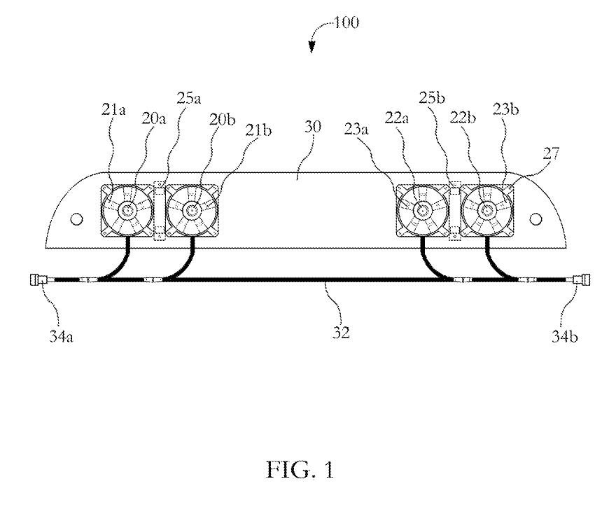

A ventilating system 100 according to the present invention is depicted in FIG. 1. The ventilating system 100 includes a backing plate 30 where the backing plate 30 provides a means to mount and install at least one ventilating fan along the surface thereof. In one particular embodiment as depicted in FIG. 1, ventilating fans according to the present invention may be mounted within the backing plate 30. Two ventilating fans 20a and 20b are mounted near one end of the backing plate 30 and ventilating fans 23a, 23b are mounted at the opposite end of a backing plate 30. The ventilating fans are mounted upon the aluminum clips 25a, 25b. Each fan includes a fan grill, depicted as fan grills 21a, 21b on one side thereof and on the opposite side fan grills 23a, 23b. A plurality of fastening devices 27 may be used to secure the fan grills and aluminum clips into place on the backing clip 30. The fastening devices 27 may include a screw, rivet, clip or stud fastener.

The ventilating fans according to the present invention transfer air into and out of the sleeping cabin area once installed. The ventilating system 100 may be fit into an existing cabin window and the backing plate 30 may be appropriately sized to fit the receiving cabin window. A wire harness 32 provides a means to supply power to each ventilating fan within the ventilating system 100. Power connections 34a, 34b are provided at each end of the wire harness 32. In one particular embodiment, the ventilating fans are supplied 12-volt DC power in order to provide energy to operate the ventilating system 100. The backing plate 30 may be made from a firm mountable material such as hard plastic or metal. The fans may operate in either direction in order to transfer hot air out of the sleeping cabin as desired and alternatively transfer cool air from the outdoor environment into the sleeping cabin.

The aluminum clips 25a, 25b provide a mounting means for the fan grills provided on the fans. In one particular embodiment of the present invention, the fans may be capable of transferring up to 268 cubic feet per minute of airflow and operating at adjustable speeds there between. Although not shown, the ventilating system 100 according to the present invention may include an on and off switch and a speed control switch mounted at the interior facing of the backing plate 30. In another alternative exemplary embodiment, the ventilating system 100 may operate continuously upon simply supplying power into the power outlets 34a, 34b.

The ventilating system 100 provides a device that circulates air and enables the driver to maintain a cooler sleeping cabin without the necessity to idle the truck and therefore waste fuel, increase engine wear and emit unnecessary emissions. The ventilating system 100 according to present invention has been able to realize up to a net gain of 2.5 miles per gallon due to the lack of unnecessary idling. Further, the ventilating system 100 provides a very high airflow due to the capability of the fans producing 268 cubic feet per minute of airflow. The instant invention has been shown and described in what it considers to be the most practical and preferred embodiments. It is recognized, however, that departures may be made there from within the scope of the invention and that obvious modifications will occur to a person skilled in the art.

What is claimed is:

1. A ventilating system for use in a sleeping cabin comprising:
a. a backing plate;
b. a plurality of fans mounted on said backing plate;
c. a plurality of fastening devices, where said fastening devices secure the fans onto the backing plate; and
d. a power supply, where said power supply supplies electrical power to the fans.

2. The ventilating system according to claim 1, further comprising aluminum clips, where said aluminum clips provide a means to support the mounting of the fans.

3. The ventilating system according to claim 1, further comprising a fan grill for each fan.

4. The ventilating system according to claim 1, where the backing plate is sized to fit a receiving cabin window.

5. The ventilating system according to claim 1, where the plurality of fastening devices include a screw, rivet, clip or stud fastener.

6. The ventilating system according to the claim 1, where the power supply includes a wire harness, where said wire harness includes power connections at each end of the wire harness.

7. The ventilating system according to claim 1, where the backing plate is made from at least one of a hard plastic and a metal.

8. The ventilating system according to claim 6, where said power supply is capable of supplying 12-volt DC power to the fans.

9. The ventilating system according to claim 1, where each fan transfers up to 268 CFM of airflow.

10. A ventilating system for use in a sleeping cabin comprising:
a. a backing plate;
b. four fans mounted on said backing plate;
c. a plurality of fastening devices, where said fastening devices secure the fans onto the backing plate; and
d. a power supply, where said power supply supplies electrical power to the fans.

11. The ventilating system according to claim 10, further comprising aluminum clips, where said aluminum clips provide a means to support the mounting of the fans.

12. The ventilating system according to claim 10, further comprising a fan grill for each fan.

13. The ventilating system according to claim 10, where the backing plate is sized to fit a receiving cabin window.

14. The ventilating system according to claim 11, where two fans are mounted near one end of the backing plate and two fans are mounted near the opposing end of the backing plate.

15. The ventilating system according to claim 10, where the plurality of fastening devices include a screw, rivet, clip or stud fastener.

16. The ventilating system according to the claim 10, where the power supply includes a wire harness, where said wire harness includes power connections at each end of the wire harness.

17. The ventilating system according to claim 10, where the backing plate is made from at least one of a hard plastic and a metal.

18. The ventilating system according to claim 16, where said power supply is capable of supplying 12-volt DC power to the fans.

19. The ventilating system according to claim 10, where each fan transfers up to 268 CFM of airflow.
